(19) United States
(12) Patent Application Publication
(10) Pub. No.: US 2023/0315867 A1
(43) Pub. Date: Oct. 5, 2023

(54) LIFECYCLE MANAGEMENT OF SECRETS IN A CLOUD MICROSERVICES ARCHITECTURE

(71) Applicant: VMware, Inc., Palo Alto, CA (US)

(72) Inventors: Igal BAKSHAN, Beit Herut (IL); Ran APEL, Even Yehuda (IL); Simon ELIASH, Tel Aviv (IL); Yaniv AHARONI, Givat Shmuel (IL); Amnon ALTONY, Ramat HaSharon (IL)

(73) Assignee: VMware, Inc., Palo Alto, CA (US)

(21) Appl. No.: 17/709,387

(22) Filed: Mar. 30, 2022

(51) Int. Cl. G06F 21/60; H04L 9/30

(52) U.S. Cl. CPC G06F 21/602; H04L 9/30

(57) ABSTRACT

Secrets are managed in a microservices architecture. According to a process flow, secret files are added to code for a microservice and tested prior to promotion to an environment. The secret files may be encrypted using public keys of the developers, and secret bundles may be created that contain the encrypted secrets as artifacts or versioned files. The artifacts may be published in an artifact repository. During promotion to a target environment, the artifact and microservice code are deployed to the target environment.

### BACKGROUND

Unless otherwise indicated herein, the approaches described in this section are not admitted to be prior art by inclusion in this section.

In a modern microservices architecture, the functionalities of an application may be provided by a suite or other collection of loosely-coupled microservices. Owners (such as developers) of the microservices can add new functionality to their microservices and independently deploy their microservices to a production environment. A microservices architecture thus brings agility and flexibility into software development by, among other things, creating independent, small, and self-deployed components.

To provide software as a service (SaaS) or other services in the cloud era, companies build continuous integration (CI) and continuous delivery (CD) pipelines to ensure that high quality features and functionality reach an end user. Although each software vendor or even a research and development (R&D) group may set their own CI/CD processes and standards, there are some industry-standards, patterns, techniques, and best practices laid-out for them.

One of these techniques is a workflow of bits from developer machines to the end-user on the production environment. The workflow may be used in connection with CI/CD for microservices, and involves a versioned artifact being compiled from developer code and promoted, typically through a development and staging environment, all the way to the production environment. The workflow may include several checkpoints or validation points such as unit tests, system tests, quality assurance (QA) signoff, etc.

Many microservices typically require several secrets in order to operate. Secrets may include a database password, an application program interface (API) key, a certificate, etc. Managing those secrets may be challenging in a multi-environment and multi-deployment microservices world. A secret is a sensitive information and should be treated accordingly. Secrets need to be protected and audited. Secret should be rotated easily, for instance, when an employee leaves a company.

There are some industry-standard tools and solutions for secret management (SM), which typically involve storing secrets securely. However, such SM tools/solutions are not easily integrated into a CI/CD workflow such as described above in a manner that is relevant or useful in a modern multi-environment SaaS application based on a microservices architecture.

### BRIEF DESCRIPTION OF DRAWINGS

FIG. 1A is a schematic diagram of a cloud computing environment that delivers services to consumers;

FIG. 1B is a schematic diagram illustrating an example virtualized computing environment that can be implemented in the cloud computing environment of FIG. 1A;

FIG. 2 is a flowchart of an example workflow process for secrets that may be implemented in the environments of FIGS. 1A and 1B;

FIG. 3 shows an example of a project and file structure having secrets;

FIG. 4 shows example test results for secrets in multiple environments;

FIG. 5 shows example contents of the artifact repository; and

FIG. 6 shows another example of a project and file structure having secrets.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be implemented in connection with other embodiments whether or not explicitly described.

The present disclosure addresses various drawbacks associated with the management of secrets in a cloud microservices architecture. As previously explained above, developers may work with SM tools on a production environment to update and add secrets, usually with a simple REST API or a command line interface (CLI) tool. However, there may not be a clear workflow process within an environment, and from one environment to another environment.

Furthermore in some situations, more than one SM tool is being used, thereby making it difficult to identify the owner of a secret and a source of truth. Although a developer should possess the skills and capabilities to access and update secrets in any environment, it can generally be an anti-pattern approach to have a developer manually update secrets on the production environment.

The embodiments described herein address the above and other drawbacks, by providing a secret management technique for microservice-based systems. Secrets may be handled as an encrypted artifact published by the microservice owners. An artifact can be versioned, can be promoted between environments, and can be rollbacked if appropriate. Also, if a secret is compromised and needs to be rotated out, a hot-patch mechanism can be applied to deliver secrets directly to the compromised environment.

Furthermore, a microservice owner is provided with capability to create new features, and deploy the features quickly through the workflow process so as to reach an end user on the production environment. In addition, microservice owners are provided with capability to promote their secret updates to the production environment using similar workflow.

As an example of various embodiments described later below, secrets may be embedded within source code, such that when the source code is promoted and deployed between environments, the secrets are promoted and deployed along with the source code as a secret bundle. In a conventional technique wherein source code is to be deployed on an environment, the environment is preliminarily configured with the secret(s) that will be used for the source code that will land in the environment—configuring the environment with the secret(s) and then delivering the source code to the environment, in a manner that the newly landed source code matches or otherwise operates properly with the secret and/or with the environment configured with the secret, is very difficult to maintain and manage. Therefore, the embodiments disclosed herein provide a process/tool to enable developers to embed the secret(s) within the source code (as a secret bundle, rather than being detached from each other as with conventional techniques), perform testing before promoting, and then promote the source code and secret together between environments—this integration of secrets with source code ensures that the secrets and source code will operate properly in the environments on which they land, in a manner that is seamless, more reliable, and easier to manage as compared to conventional techniques.

Computing Environment

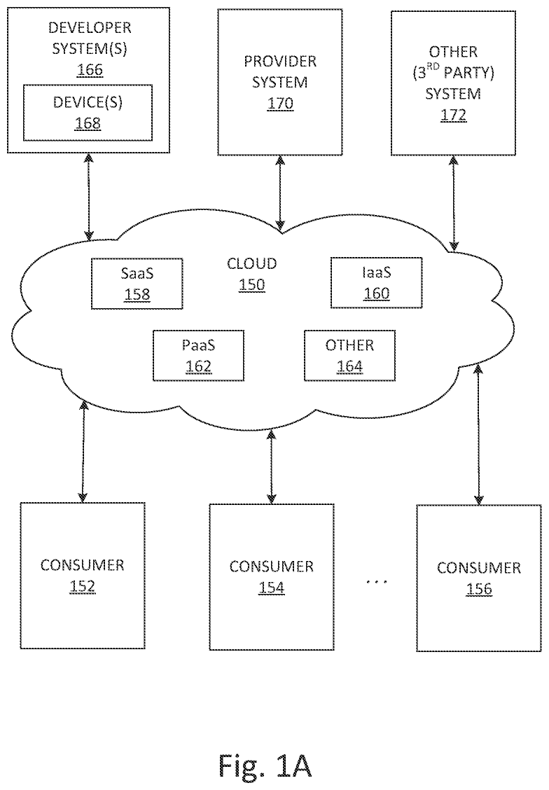

Referring first to FIG. 1A, a cloud computing environment (which may generally be referred to as a cloud 150) delivers various services to consumers 152-156 through a network (such as the Internet). Such services may include software as a service (SaaS) 158, infrastructure as a service (IaaS) 160, platform as a service (PaaS) 162, and/or other services 164. For instance, microservices are examples of components that may be provided as part of the SaaS 158.

The backend of the cloud 150 (e.g., within the cloud 150) that supports the delivery of the services 158-164 to the consumers 152-156 may be comprised of computing devices, storage units (including databases), hardware, software, virtual and physical components, etc. within the cloud 150. The consumers 152-156 may comprise end users, customers, system administrators, or other entities that access and consume/use the services 158-164 via user devices (such as mobile or desktop computing devices having browsers) at the front end of the cloud 150.

The services (such as microservices associated with the SaaS 158) at the cloud 150, which are made available for delivery to or consumption by the consumers 152-156, may be thought of as being deployed on a production environment. Other environments upstream of the production environment may include environments wherein various systems develop, test, update, and provide services and other components for promotion or delivery to the production environment.

For example, one or more developer systems 166 may develop and provide at least some of the services 158-164 (including microservices) to the cloud 150. The developer system 166 may be used by developer teams to implement continuous integration (CI) and continuous delivery (CD) pipelines to deliver microservices (including updates) to the production environment at the cloud 150 for consumption by the consumers 152-156.

The developer systems 166 may include computing devices 168 that are used by developer team members to create, test, etc. microservices using a development workflow. Such a development workflow of various embodiments may include the generation and management of secrets within the code of the microservices. Such generation/management of secrets in the development workflow will be described in further detail later below.

A provider system 170 may manage or operate the infrastructure and/or services provided by the cloud 150. For example, the provider system 170 may use the developer system 166 and/or other developer system to develop and push/deliver services and updates to the cloud 150, may provide and maintain the computing devices and related hardware to enable the cloud 150 to deliver the services 158-164, may integrate hardware/software products and tools from other entities (such as a third party system 172) into the cloud 150, etc. The third party system 172 may provide a secret store/vault, for example.

FIG. 1B is a schematic diagram illustrating an example virtualized computing environment 100 that can be implemented in the cloud computing environment of FIG. 1A. For instance, components of the virtualized computing environment 100 may provide some of the computing infrastructure for the backend of the cloud 150 to enable the delivery of services 158-164 to the consumers 152-156. Depending on the desired implementation, the virtualized computing environment 100 may include additional and/or alternative components than that shown in FIG. 1B.

In the example in FIG. 1B, the virtualized computing environment 100 includes multiple hosts, such as host-A 110A . . . host-N 110N that may be inter-connected via a physical network 112, such as represented in FIG. 1B by interconnecting arrows between the physical network 112 and host-A 110A . . . host-N 110N. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., hypervisor-A 116A) to support various virtual machines (VMs). For example, the host-A 110A supports VM1 118 . . . VMY 120, wherein Y (as well as N) is an integer greater than or equal to 1. In practice, the virtualized computing environment 100 may include any number of hosts (also known as “computing devices”, “host computers”, “host devices”, “physical servers”, “server systems”, “physical machines,” etc.), wherein each host may be supporting tens or hundreds of virtual machines. For the sake of simplicity, the details of only the single VM1 118 are shown and described herein.

VM1 118 may include a guest operating system (OS) 122 and one or more guest applications 124 (and their corresponding processes) that run on top of the guest operating system 122. The applications 124 may include services (including microservices) that are developed by the developer system 166 of FIG. 1B and then delivered to the production environment (e.g., the hosts in the virtualized computing environment 100 of FIG. 1B) for use or other consumption by end users or other entities. VM1 118 may include still further other elements 128, such as a virtual disk, agents, engines, modules, and/or other elements usable in connection with operating VM1 118.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs.

The hypervisor-A 116A may include or may operate in cooperation with still further other elements 140 residing at the host-A 110A. Such other elements 140 may include drivers, agent(s), daemons, engines, virtual switches, and other types of modules/units/components that operate to support the functions of the host-A 110A and its VMs.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

A management server 142 (or other network device configured as a management entity) of one embodiment can take the form of a physical computer or with functionality to manage or otherwise control the operation of host-A 110A . . . host-N 110N. In some embodiments, the functionality of the management server 142 can be implemented in a virtual appliance, for example in the form of a single-purpose VM that may be run on one of the hosts in a cluster or on a host that is not in the cluster of hosts.

A user (e.g., associated with one of the consumers 152-156 of FIG. 1A) may operate a user device 146 to access, via the physical network 112, the functionality of VM1 118 . . . VMY 120 (including operating the applications 124 and related microservices), using a web client 148 (such as a browser-based application). The user device 146 can be in the form of a computer, including desktop computers and portable computers (such as laptops and smart phones).

Workflow Process for Secrets

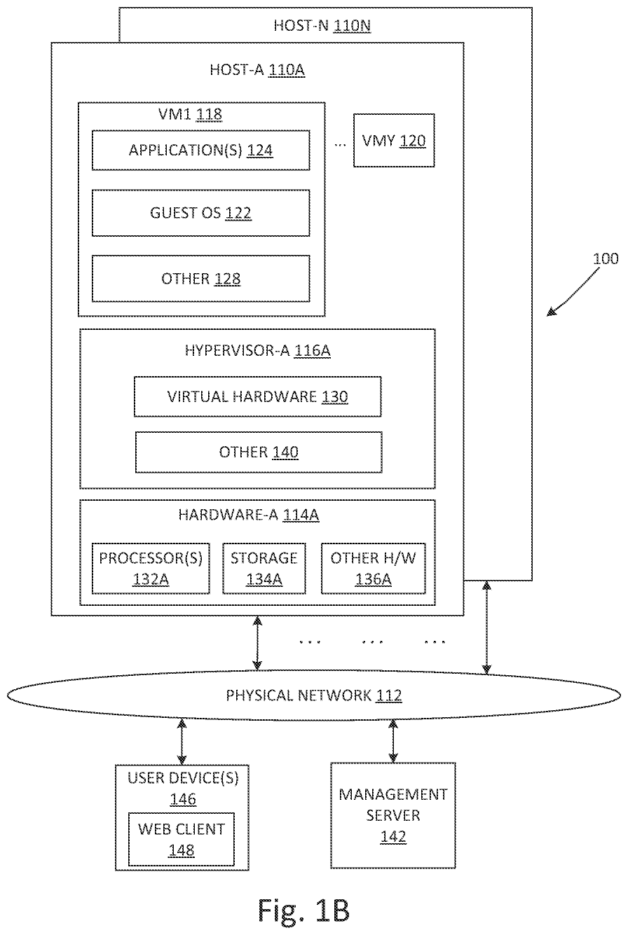

FIG. 2 is a flowchart of an example workflow process 200 for secrets that may be implemented in the environments of FIGS. 1A and 1B. For instance, the workflow process 200 may be a workflow/method implemented in the developer system 166 of FIG. 1A in connection with developing and delivering services (such as microservices and updates) from the developer machine (e.g., the computing device(s) 168 of FIG. 1A) to the cloud 150. The computing device(s) 168 or some other computing/network device(s) may perform at least some of the operations of the workflow process 200.

The example workflow process 200 may include one or more operations, functions, or actions illustrated by one or more blocks, such as blocks 202 to 212. The various blocks of the workflow process 200 and/or of any other process(es) described herein may be combined into fewer blocks, divided into additional blocks, supplemented with further blocks, and/or eliminated based upon the desired implementation. In one embodiment, the operations of the workflow process 200 and/or of any other process(es) described herein may be performed in a pipelined sequential manner. In other embodiments, some operations may be performed out-of-order, in parallel, etc.

The workflow process 200 begins at a block 202 (“DEVELOPMENT”), wherein a developer uses the computing device 168 to write the business logic (BL) code and/or other code (such as source code, etc.) that consumes one or more secrets. The developer than adds the secrets (such as in a file format) to the code.

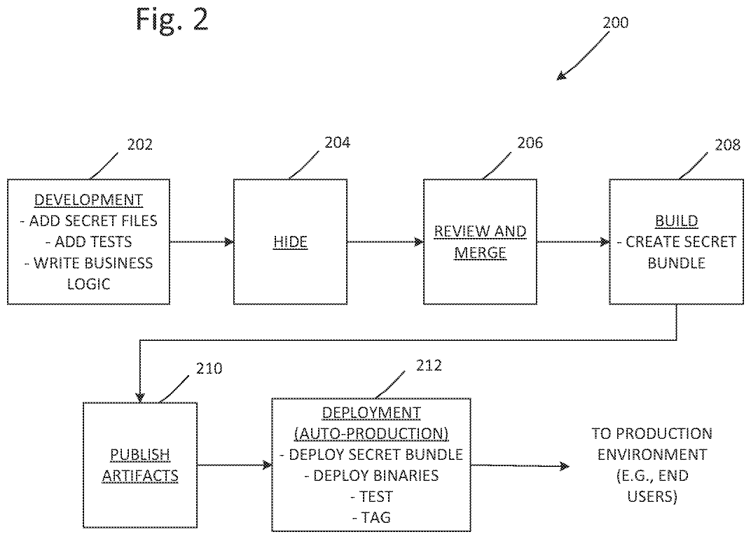

FIG. 3 shows an example of a project and file structure 300 having secrets, which may be generated at the block 202. In the example of FIG. 3, the project being worked on by the developer team is a usage meter (UM) for a cloud services platform (CSP) product or any other related cloud-based product, for merely illustrative purposes. The project and file structure 300 may be represented/provided, for example, as a directory tree in a Git report.

The example project and file structure 300 of FIG. 3 may include, for the CSP UM project, a plurality of folders 302 containing the source code for various components of the UM microservice, a continuous integration/continuous delivery (CICD) folder 304 containing scripts for secret bundles that will be described later below, and a secrets folder 306. Other and/or additional folders and contents may be provided in other embodiments of the project and file structure 300.

In the example of FIG. 3, the secrets folder 306 may in turn include a plurality of sub-folders. For instance, there may be a commercial folder 308 that contains the secrets for the development team that works on a commercial product, a government folder 310 that contains the secrets for the development team that works on a product for government use, and a team folder 312 that contains the public and/or private keys of development team members and other information regarding development team members.

As an illustration with respect to the commercial folder 308, sub-folders 314 may include secrets for each respective one of the development (DEV), playground, production, preview, and staging environments. With respect to the development environment sub-folder, FIG. 3 shows two secret files SECRET 1 and SECRET 2. These secret files may be .yaml files or some other format of a text file. With respect to the secret file SECRET 1, a viewing window 316 shows that the secret file SECRET 1 may contain, among other things, the cleartext file 318 of the secret and a key 320 (such as a public key that may be used to encrypt the secret, or a private key that may be used to decrypt an encrypted secret).

Referring now back to the block 202 in the workflow process 200 of FIG. 2, the developer writes tests for the secrets at the block 202, and runs the tests. In this testing, the secrets are run on the developer's machine along with the BL code (and/or with other source code) for each environment, prior to actually being landed on the environment, so as to ensure that the code (and secrets) will operate as expected when they land on that target environment.

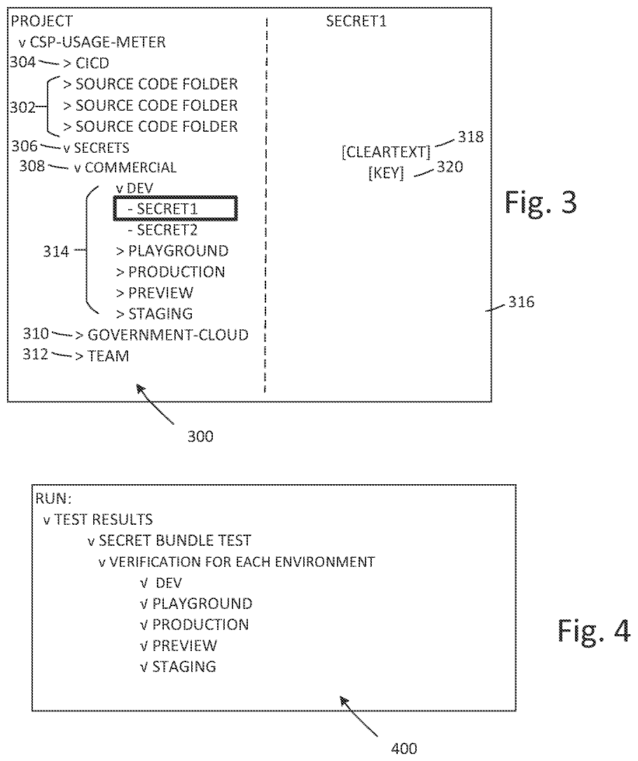

For instance, FIG. 4 shows example test results 400 for secrets in multiple environments (development, playground, production, preview, and staging). An example test may involve using the secrets to generate a token. If a token is generated successfully (indicated by a √ mark in FIG. 4) in each environment on which the test is run, then there is a high degree of confidence that the source code and secret will run successfully when they actually land on the target environment. Multiple tests may be run for each environment for the testing aspect of the block 202. Other testing techniques may be used, alternatively or additionally to generating tokens.

The block 202 may be followed by a block 204 (“HIDE”) in the workflow process 200 of FIG. 2. At the block 204 and after successful completion of the testing, the developer uses the developer machine (e.g., the computing device 168) to encrypt the secrets and remove the cleartext file 318 (e.g., replace the cleartext file 318 with a ciphertext file). GNU privacy guard (GPG) encryption is one example encryption technique that may be used. According to various embodiments, the encryption may be performed to encrypt the secret (e.g., the secret file), while other folders/files in the project and file structure 300 remain unencrypted. For example, the secret file may be encrypted, while the source code or BL code (and/or other executable code) is not encrypted.

For instance, the public keys of all development team members and/or other public keys may be used to encrypt the secret. A keyring may be generated from the public keys of the development team members, and the development team owns the keyring and is responsible managing the keyring. The keyring in some embodiments is part of the code repository and contains the public keys of the relevant team members (e.g., contained in the team folder 312 shown in FIG. 3). The development team may also add the public key of the CI user to the keyring, so that the CI process will be able to subsequently extract the secrets.

The secret may later be decrypted using the private keys of the team members and/or of other owners/entities. Various tools may be used to add or remove team members from the keyring, and also to hide and reveal secrets. In some embodiments, some files such as the keyring, may be binary files that are not visible for review.

The block 204 may be followed by a block 206 (“REVIEW AND MERGE”) in the workflow process 200 of FIG. 2. At the block 206, a reviewer in the development team uses the computing device 168 to review the files/content in the project and file structure 300, for purposes of quality control, verifying operability, standards compliance, etc.

According to various embodiments, the reviewer's public key is part of the keyring having the key(s) that were used to encrypt the secret file. This enables the reviewer's private key to be used to decrypt and view the secret file for the review process at the block 206, including reviewing updates/changes by comparing versions of files.

The merging at the block 206 may be performed after the reviewer approves the changes. Merging may include integrating changes or other work product from multiple developers of the development team, into the codebase or source control for the project and file structure 300.

The block 206 may be followed by a block 208 (“BUILD”) in the workflow process 200 of FIG. 2, in which a secret bundle is created. For instance and as part of the CI/CD process, artifacts (e.g., versioned files) may be built at the block 208. These artifacts may include at least two artifacts: a binary artifact corresponding to the source/BL code and an artifact holding the secret(s) which is the secret bundle (SB).

The secret bundles may be placed in the CICD folder 304 in the project and file structure 300 of FIG. 3. For instance, the CICD folder 304 may contain .sh files/scripts that are executed to create secret bundle files, such as in the form of .tar files.

An individual secret bundle may be made up of one or more versioned secret files. Each individual versioned file may have different content/features/capabilities relative to other versioned files. Thus, when the source code and corresponding secret file(s) land in an environment as a packaged artifact, the behavior/operation of the microservice may differ depending on which version is being landed in the environment.

Versioning the secret files in this manner enables rollback or other processes that involve (when needed) changing from one code version to another, within an environment and when promoting from one environment to another. The artifacts may be in the form of versioned executable files, such as .exe, .jar, .tar etc. files, docker images, and so forth.

The block 208 may be followed by a block 210 (“PUBLISH ARTIFACTS”) in the workflow process 200 of FIG. 2. At the block 208, the binary artifacts and secret bundles are stored in an artifact repository (artifactory) and published. The appropriate artifacts may thus be selected from the artifactory, and deployed from the artifactory and into a target environment. The artifactory may be located in a database or other storage device at the developer system 166 of FIG. 1 and/or elsewhere.

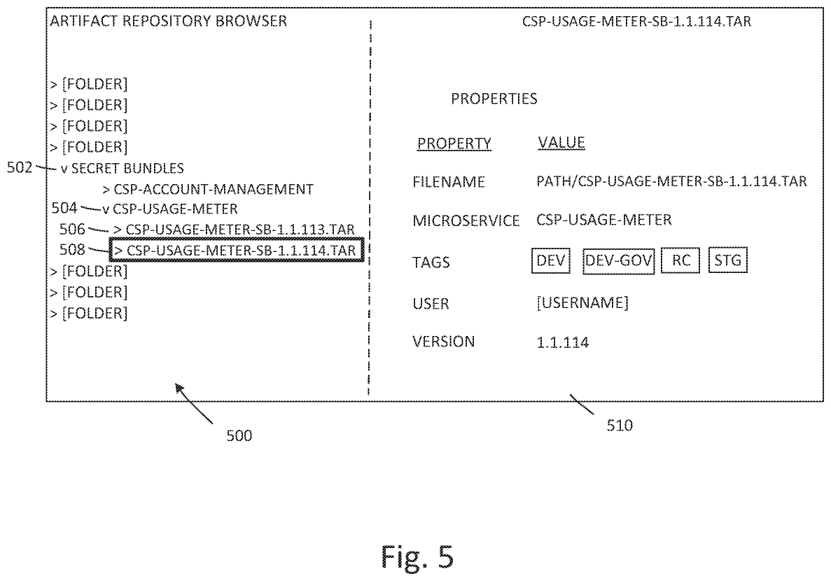

FIG. 5 shows example contents of the artifact repository, which may be viewed via a browser interface. The contents may be arranged in a directory tree 500, with a folder 502 containing the secret bundles, including a secret bundle sub-folder 504 containing two artifacts 506 and 508 for the CSP usage meter microservice. Examples of these artifacts 506 and 508 are respectively shown in FIG. 5 as versioned files named csp-usage-meter-sb-1.1.113.tar and csp-usage-meter-sb-1.1.114.tar.

Example properties of the versioned file csp-usage-meter-sb-1.1.114.tar are shown in a viewing window 510 of the browser interface. These properties may include, for example, the filename of the secret bundle (including path information in the directory tree 500), the microservice, tags, user (developer) identification, and version number. The tags may identify the environments (e.g., development (DEV), staging (STG), release candidate (RC), etc.) where the secrets have been reviewed/verified to be operational.

Referring now back to FIG. 2, the block 210 may be followed by a block 212 (“DEPLOYMENT”) in the workflow process 200 of FIG. 2, in which the artifacts are deployed in an automation environment. The operations performed at the block 210 may include deploying the secret bundle and then deploying the binaries in a target environment, automation testing at the target environment, and tagging the artifacts after successful testing (e.g., with the RC tag). According to some embodiments, the secret artifacts are deployed from the artifactory to a secret management (SM) solution (e.g., Vault) before the artifact(s) for code land(s) in the target environment—thus, once the artifact(s) for the code land(s) in the target environment, the corresponding secrets are already available.

Code and secret files may be present in at least three locations: in a development tool repository (e.g., a Git repository), in an artifactory, and in a server or other computing device that runs the code/secret in the environment. Source code (such as in a Git repository) may be in state of development and so may not be fully functional or tested (yet). As explained above, an artifactory may contain specific executable versioned snapshots of code. Each snapshot can be logically tagged as a release candidate (RC), as a hot patch, for a specific environment, etc. The code can continue to be developed and can continue its mutation/evolution while the artifact (e.g., a snapshot) may stay static in the artifactory. The artifactory enables deployment of an artifact after any period of time and with the same result being expected (while the code itself may have changed).

Artifacts with the RC tag can be graduated/promoted to a next environment (if/when appropriate). Promoting an artifact can be performed as part of a promotion flow or using a more rapid process designed for hot patches. Applying a hot patch can skip an entire promotion flow and need not require going through all quality gates (e.g., testing) and intermediate environments.

If a problem occurs during deployment in an environment, the workflow process can revert back to the last known healthy version of the secret bundle. For instance, rollbacks may be performed by deploying the secret bundle having the most recent tag corresponding to a previous environment where the secret bundle was tested successfully.

According to various embodiments, the secret bundles stored in the artifactory may serve as the single source of truth. Thus, for instance, if the artifact/secrets are misconfigured for an environment, or if clusters/nodes in the environment lose their state, restoration can be performed on a new node using the secret bundle. This capability may be used in scenarios such as disaster recovery or other scenarios.

Storing multiple versions of code and corresponding secrets in the artifactory provides a number of advantages/capabilities. Different versions of the code (and their corresponding secrets) can be provided for respective different environments, such as a different version for each of the development, staging, and production environments. Versions that fail testing or QA may also be stored for reference. As another example, code may be deployed on a per-user basis such that different users/customers may be provided with respective different versions of code. The secrets (e.g., secret bundles) that correspond to these different versions of code accompany the code to the target environment and so are available for use by the versions of code in the target environment.

The embodiments described above pertained to code and corresponding secrets for environments such as development, staging, production, commercial, government, etc. environments. These may be multi-tenant environments in that for each individual environment, there may be multiple tenants (e.g., customers). Each environment serves multiple customers, and there is a logical separation between the customers in the environment.

The embodiments described above pertaining to code and corresponding secrets may also be applied to dedicated environments, such as an environment dedicated to a specific customer (e.g., a user or tenant). For instance, the customers may be customer1, customer2, customer3, tenant1, tenant2, etc. In such an implementation, there may be a physical separation between the customers, such as separate dedicated server(s) and dedicated SM tool (e.g., Vault) for each customer.

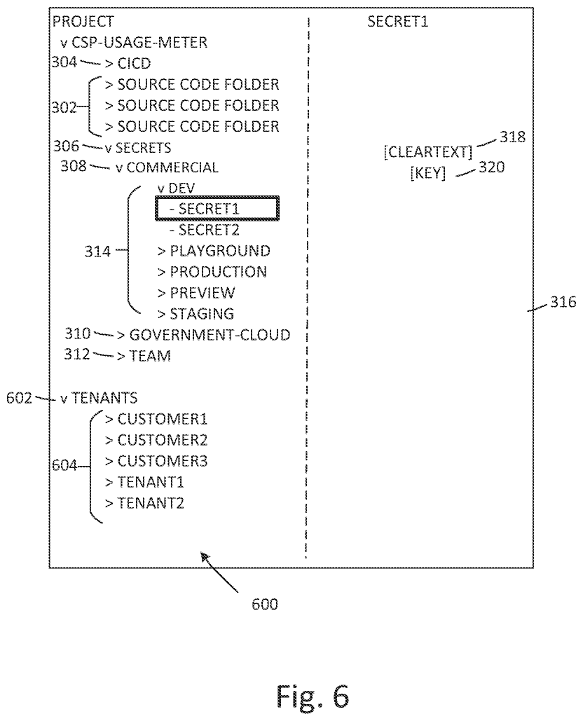

Secret folder structures, secret bundles, etc. such as described above can be used for such dedicated customer implementations. For instance, FIG. 6 another example of a project and file structure having secrets. More specifically, FIG. 6 has some similarities to FIG. 5 previously described above, except FIG. 6 shows a directory structure 600 having a tenant folder 602. The tenant folder 602 in turn includes subfolders 604 for respective different tenants/customers/users customer1, customer2, customer3, tenant1, tenant2, etc. Each of the subfolders 604 may correspond to a separate server for each customer, for instance.

Each of the individual subfolders 604 may in turn contain further subfolders, files, codes, keys, secrets, etc., similar to what was described above with respect to the directory and file structure of FIG. 3. In this manner, per-tenant secret management may be provided.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1A to 6.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to more efficiently manage the lifecycle of secrets.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to manage secrets in a microservices architecture, the method comprising:
generating code for a microservice;
adding a secret for the code for the microservice;
encrypting the secret for the code of the microservice to generate an encrypted secret file;
creating a secret bundle that includes at least a first artifact that corresponds to a version of the encrypted secret file;
creating at least a second artifact that corresponds to the code for the microservice; and
promoting the first and second artifacts to a target environment.

2. The method of claim 1, further comprising publishing at least the first artifact in an artifact repository.

3. The method of claim 1, further comprising testing the secret before promotion to a next environment so as to verify that the secret and code operate correctly in all target environments.

4. The method of claim 3, wherein testing the secret comprises determining whether the secret successfully generates a token.

5. The method of claim 3, further comprising tagging the secret to indicate that the secret has been tested and has operated successfully with the code in a particular environment.

6. The method of claim 1, wherein encrypting the secret includes encrypting the secret using public keys of at least some members of a development team for the microservice, wherein the public keys are provided in a keyring, and wherein the method further comprises:
decrypting the encrypted secret using a private key of at least one member of the development team, including decrypting the encrypted key during a review of the code having the secret.

7. The method of claim 1, wherein the secret includes at least one of a password, an application program interface (API) key, or a certificate.

8. A non-transitory computer-readable medium having instructions stored thereon, which in response to execution by one or more processors, cause the one or more processors to perform or control performance of a method to manage secrets in a microservices architecture, wherein the method comprises:
generating code for a microservice;
adding a secret for the code for the microservice;
encrypting the secret for the code of the microservice to generate an encrypted secret file;
creating a secret bundle that includes at least a first artifact that corresponds to a version of the encrypted secret file;
creating at least a second artifact that corresponds to the code for the microservice; and
promoting the first and second artifacts to a target environment.

9. The non-transitory computer-readable medium of claim 8, wherein the method further comprises publishing at least the first artifact in an artifact repository.

10. The non-transitory computer-readable medium of claim 8, wherein the method further comprises testing the secret before promotion to a next environment so as to verify that the secret and code operate correctly in all target environments.

11. The non-transitory computer-readable medium of claim 10, wherein testing the secret comprises determining whether the secret successfully generates a token.

12. The non-transitory computer-readable medium of claim 10, wherein the method further comprises tagging the secret to indicate that the secret has been tested and has operated successfully with the code in a particular environment.

13. The non-transitory computer-readable medium of claim 8, wherein encrypting the secret includes encrypting the secret using public keys of at least some members of a development team for the microservice, wherein the public keys are provided in a keyring, and wherein the method further comprises:
decrypting the encrypted secret using a private key of at least one member of the development team, including decrypting the encrypted key during a review of the code having the secret.

14. The non-transitory computer-readable medium of claim 9, wherein the secret includes at least one of a password, an application program interface (API) key, or a certificate.

15. A system to manage secrets in a microservices architecture, the host comprising:
one or more processors; and
one or more non-transitory computer-readable media coupled to the one or more processors, and having instructions stored thereon, which in response to execution by the one or more processors, cause the one or more processors to perform or control performance of operations that include:
generate code for a microservice;
add a secret for the code for the microservice;
encrypt the secret for the code of the microservice to generate an encrypted secret file;
create a secret bundle that includes at least a first artifact that corresponds to a version of the encrypted secret file;
create at least a second artifact that corresponds to the code for the microservice; and
promote the first and second artifacts to a target environment.

16. The system of claim 15, wherein the operations further include:
publish at least the first artifact in an artifact repository.

17. The system of claim 15, wherein the operations further include:
test the secret before promotion to a next environment so as to verify that the secret and code operate correctly in all target environments.

18. The system of claim 17, wherein the operations to test the secret includes operations to determine whether the secret successfully generates a token.

19. The system of claim 17, wherein the operations further include:
tag the secret to indicate that the secret has been tested and has operated successfully with the code in a particular environment.

20. The system of claim 15, wherein the operations to encrypt the secret include operations to encrypt the secret using public keys of at least some members of a development team for the microservice, wherein the public keys are provided in a keyring, and wherein the operations further include:
decrypt the encrypted secret using a private key of at least one member of the development team, including decryption of the encrypted key during a review of the code having the secret.

21. The system of claim 15, wherein the secret includes at least one of a password, an application program interface (API) key, or a certificate.
